(19) United States
(12) Patent Application Publication
(10) Pub. No.: US 2010/0000110 A1
(43) Pub. Date: Jan. 7, 2010

(54) VACUUM MICROWAVE DRYING APPARATUS

(76) Inventor: Sheng Li, Gansu Province (CN)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/438,650

(22) PCT Filed: Aug. 24, 2007
(86) PCT No.: PCT/CN2007/002569

§ 371 Date: Jun. 15, 2009

(30) Foreign Application Priority Data
Aug. 24, 2006 (CN) 200620079680.1

(51) Int. Cl. F26B 3/347

(52) U.S. Cl. 34/259

(57) ABSTRACT

A vacuum microwave drying apparatus, includes: a tank (1); a tank enclosure (2), which defines an accommodate space with the tank; a vacuum system, which is communicated with the accommodate space through a vacuum pipe (5); a continuous feed-in mechanism (9), including a feed-in pipe (902) communicated with the accommodate space, the continuous feed-in mechanism (9) sending materials into the accommodate space through the feed-in pipe (902) continuously; a continuous feed-out mechanism (10), which sends the materials out of the accommodate space continuously; at least two layers of material sending mechanisms (3), each of which is arranged in the accommodate space in parallel along the longitudinal direction of the tank, to send the materials from the continuous feed-in mechanism (9) into the continuous feed-out mechanism (10); and a plurality of microwave heating devices (4), each of which has a microwave feed-in port (403), which is located in the accommodate space, to send microwave to the accommodate space, the microwave being used to dry the materials which is sent by the material sending mechanism (3). The vacuum microwave drying apparatus can reduce the occupied space, and can perform a continuous drying operation.

### BACKGROUND OF THE INVENTION

1. Field of the Invention

The present invention relates to a material drying and sterilizing equipment utilized in a field such as pharmacy, foodstuff, chemical engineering, paper-making, particularly, relates to a vacuum microwave drying equipment.

2. Description of Related Art

In many fields, such as pharmacy, foodstuff chemical engineering, paper-making and so on, a material drying process is usually related.

A conventional material drying method includes the steam drying method and the microwave drying method, etc. The steam drying method has defects such as long drying cycle, large power consumption, low efficiency, non-homogeneous heating, poor performance of preserving freshness, and so on. Though the microwave drying method can increase the rate of material drying, but owing to the higher drying temperature, the drying quality and performance of the material is prone to be affected.

The microwave vacuum drying method developed in recent years incorporates the advantages of both the microwave technique and vacuum drying technique. When the material is dried under a condition of vacuum, because the vacuum environment ensures that the material is dried in a cold condition, and microwave drying is of the instant high efficiency, a rapid and low temperature drying can be realized.

Chinese patent of utility model with a publication No. CN2620843 and a title “extractive material microwave vacuum drier”, disclosed a technical solution, which adds a microwave heating process on the basis of an original vacuum heating process and follows the character that the energy transmission of the microwave under a vacuum condition is not affected by the surrounding, the moisture content included in the drug is evaporated rapidly through the microwave heating process, thereby a target of quick-drying is achieved. This technical solution has the following defects: the transmission and discharging of the material is discontinuous during the material is dried, the utilization ratio of microwave is low and the drying effect is not ideal. Therefore, the above solution results in a poor productivity and is unable to satisfy the real production demand of drying material in large quantity.

Chinese patent of utility model with a publication No. CN2514278 and a title “transparent liquid low temperature automatic drier”, disclosed another technical solution, in which “a steam thermal radiation panel, several continuous thermal radiation panels, and a refrigeration panel are provided in sequence” on a transport belt of a vacuum drier, so that the material on the transport belt is transferred from a high temperature region to a low temperature region. Because a temperature gradient between the high temperature region and the low temperature region is unobvious, the amount of the moisture content of the material dried by utilizing this solution may not meet the demands of the real production.

### BRIEF SUMMARY OF THE INVENTION

One object of the present invention is to provide a continuous mode vacuum microwave drying apparatus which can take full advantage of the device space and may improve the microwave utilization ratio.

Another object of the present invention is to provide a continuous mode vacuum microwave drying apparatus which can dry material continuously, thereby the productivity is raised.

Another object of the present invention is to provide a continuous mode vacuum microwave drying apparatus which can decrease the amount of the moisture content in the dried material by increasing a temperature gradient between a high temperature region and a low temperature region.

To realize the above objects, the present invention provides a vacuum microwave drying apparatus, comprising: a tank; a tank closure, defining a containing space together with the tank; a vacuum system, communicated with the containing space via a vacuum tube; a continuous feeding mechanism, comprising a feeding pipe communicated with the containing space, for transferring the material to the containing space continuously via the feeding pipe; a continuous discharging mechanism, for discharging the dried material out of the containing space; at least two layers of material transferring mechanism, provided in the containing space along a longitudinal direction of the tank and being parallel to each other in an up and down direction, for transferring the material to the continuous discharging mechanism from the continuous feeding mechanism; and a plurality of microwave heating means, provided with microwave feed-in openings arranged in the containing space to transfer microwave to the containing space, the microwave is used for drying the material being carried on the material transferring mechanism.

Preferably, the plurality of microwave heating means are arranged to be multi-line parallel to the material transferring mechanism, each line of the microwave heating means is corresponding with each layer of the material transferring mechanism respectively, so that the microwave feed-in openings of each line of microwave heating means approach to the material being carried on the corresponding layer of the material transferring mechanism.

Preferably, the microwave heating means comprises: a microwave generator, located outside the tank and being electrically connected with a microwave power supply to generate microwave; a microwave conveyor, for conveying the microwave generated by the microwave generator to the microwave feed-in opening; wherein the length of each microwave conveyor is equal, the microwave feed-in opening is arranged on the microwave conveyor and faces towards the material.

Preferably, the microwave heating means comprises: a microwave generator, located outside the tank and being electrically connected with a microwave power supply to generate microwave; a microwave conveyor, for conveying microwave generated by the microwave generator to the microwave feed-in opening; wherein the microwave feed-in opening is placed at a free end of the microwave conveyor, and the length of each microwave conveyor increases or decreases gradually along the transverse direction of the tank, so that the material being transferred by the material transferring mechanism can be fully irradiated by microwave.

Preferably, 2-8 layers of the material transferring mechanism are provided.

Preferably, the microwave feed-in opening is arranged at the inner circumference of the tank.

Preferably, the microwave feed-in openings are arranged along the radial direction of said tank and are aligned to multi-line along an axial direction of the tank.

Preferably, 2 layers of the material transferring mechanism are provided.

Preferably, the vacuum microwave drying apparatus further comprises a video monitoring system for monitoring the containing space.

Preferably, the feeding pipe comprises a feeding branch pipe, whose quantity and position is correspondent to those of the material transferring mechanism, the continuous feeding mechanism still comprises: a stirring kettle, for stirring the material; and a transfer pump, being arranged in the pipe together with the stirring kettle, for transferring the material into the transferring mechanism in the containing space.

Preferably, the continuous discharging mechanism comprise: a material catching pot, for catching the dried material unloaded from the material transferring mechanism; a spiral propeller, for pushing the material in the material catching pot; and a discharge port, being communicated with the material catching pot, the material is discharged out of the containing space through the discharge port.

Preferably, the material transferring mechanism comprises: a leading roll, arranged at one end in the containing space and driven by a drive unit outside the tank; a driven roll, arranged at the other end in the containing space; and an endless belt conveyor, provided with a carrying surface for loading the material, and looped on the leading roll and the driven roll to transfer the material.

Preferably, the vacuum microwave drying apparatus further comprises: an elastic perching knife, arranged to touch the carrying surface of the material transferring mechanism so as to clear the material remaining on the endless belt conveyor after unloading; and a hairbrush comprising many hairs, located at the downstream of the elastic perching knife and arranged to touch the carrying surface of the material transferring mechanism so as to clear the material remaining the endless belt conveyor after unloading.

Preferably, the material transferring mechanism is a flat belt transfer mechanism or a track transfer mechanism.

Preferably, the vacuum microwave drying apparatus further comprises: a mill roll, located on the carrying surface of each material transferring mechanism, for milling the material on the carrying surface; and a mill slab, located below the carrying surface of each material transferring mechanism, and cooperating with the mill roll to mill the material.

Preferably, the vacuum microwave drying apparatus further comprises: a cutter for cutting the material, located on the carrying surface of each material transferring mechanism; and a cutting slab, located below the carrying surface of each material transferring mechanism, and cooperating with the cutter to cut the material.

Preferably, the vacuum microwave drying apparatus further comprises: a separator, made from a microwave separation material and dividing the containing space into a drying chamber and a cooling chamber, the drying chamber being connected with the continuous feeding mechanism, the cooling chamber being connected with the discharging mechanism, and the separator being provided with a separator opening whose position and quantity is corresponding to those of the endless belt conveyor so that the endless belt conveyor may pass through the separator opening; and a cooling unit for cooling the material, located in the cooling chamber; wherein a plurality of the microwave heating means are arranged in the drying chamber to dry the material in the drying chamber.

Preferably, a microwave suppressor with a suppressor opening, through which the endless belt conveyor is passed, is further provided in the cooling chamber, the microwave suppressor is utilized to reduce the microwave leaked from the suppressor opening.

Preferably, the microwave suppressor is an absorption type microwave suppressor, a reflection type microwave suppressor or a filtration type microwave suppressor.

Preferably, the vacuum microwave drying apparatus further comprises a frozen chamber arranged in the containing space and defining a closed frozen space, and the material transferred to the material transferring mechanism via the feeding pipe is carried by the material transferring mechanism and passes through the frozen chamber.

Preferably, an intermittent refrigeration board is arranged in the containing space and below the belt conveyor of the material transferring mechanism, so that the material is dried and refrigerated repeatedly during transportation of the material.

Preferably, an integral refrigeration board is arranged in the containing space and below the belt conveyor of the material transferring mechanism, so that the material is dried while being refrigerated during transportation of the material.

Because the material transferring mechanism is arranged to multilayer in the same one tank, the above vacuum microwave drier provided by the present invention can take full advantage of device space and improve utilization ratio of microwave; In addition, because the continuous feeding mechanism, the continuous discharging mechanism and the material transferring mechanism can run continuously, the drying operation of material is performed continuously. Furthermore, the containing space in the tank is divided into the drying chamber and the cooling chamber by the separator, the temperature gradient between the drying chamber and cooling chamber is increased, thereby helps the reduction of the moisture content in the dried material.

### BRIEF DESCRIPTION OF THE DRAWINGS

The inclusive figures, which are incorporated into the specification and constitute a part of the specification, offer a further comprehension to the present invention. Said figures show the embodiments of the present invention and are used for explaining the principle of the present invention together with the specification. The similar figure reference represents the similar part in the figures, in which:

FIG. 1 is a schematic view showing a structure of a vacuum microwave drier according to the first embodiment of the present invention.

FIG. 2 is a sectional view cut along A-A line of FIG. 1 of the present invention.

FIG. 3 is a schematic view showing a structure of a vacuum microwave drying apparatus according to the second embodiment of the present invention.

FIG. 4 is a sectional view cut along line B-B of FIG. 3.

FIG. 5 is a section view (I) cut along line C-C of FIG. 3, in which the length of microwave conveyors is equal.

FIG. 6 is a section view (II) cut along line C-C of FIG. 3, in which the length of microwave conveyors is not equal.

FIG. 7 is a schematic view showing a structure of a vacuum microwave drying apparatus according to the third embodiment of the present invention, in which a containing space in a tank is divided into a drying chamber and a cooling chamber by a separator.

FIG. 8 is a sectional view cut along line D-D of FIG. 7.

FIG. 9 is a schematic view showing a structure of a vacuum microwave drying apparatus according to the fourth embodiment of the present invention.

FIG. 10 is a schematic view showing a structure of a vacuum microwave drying apparatus according to the fifth embodiment of the present invention.

Wherein the reference characters is shown as follows:
1 tank
2 tank closure
3 material transferring mechanism
   31 leading roll
   32 driven roll
   33 endless belt conveyor
4 microwave heating means
   401 microwave generator
   402 microwave conveyor
   403 microwave feed-in opening
5 vacuum pipe
6 clearing means
7 monitoring system
8 locking means
9 continuous feeding mechanism
   901 feeding pump
   902 feeding pipe
   903 feeding branch pipe
10 continuous discharging mechanism
   1001 material catching pot
   1002 spiral propeller
   1003 discharge port
11 support
12 separator
13 microwave suppressor
14 mill roll
15 mill slab
16 cutter
17 cutting slab
18 elastic perching knife
19 hairbrush
20 cooling pipe
21 frozen chamber
22 refrigeration system
23 first separation wall
24 second separation wall
25 refrigeration board

### DETAILED DESCRIPTION OF THE INVENTION

In order to further explain the principle and structure of the present invention, now the preferred embodiments of the present invention will be described in detail with reference to the figures.

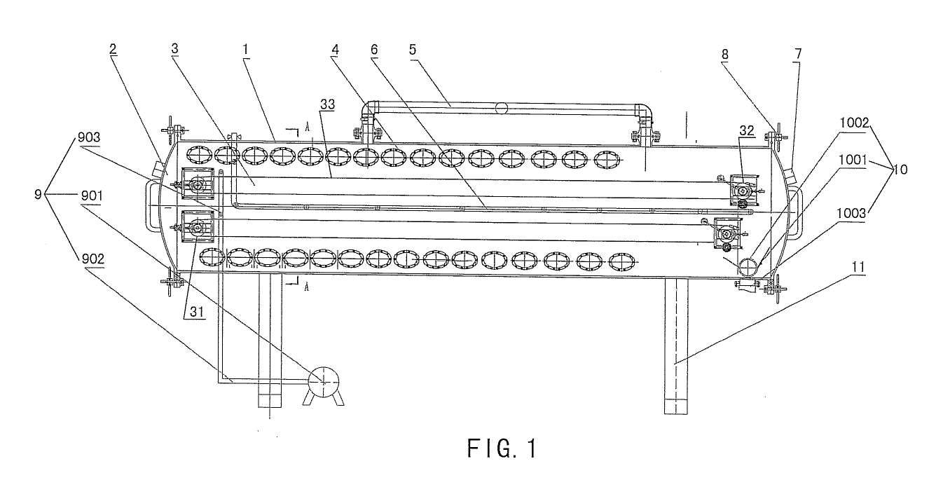

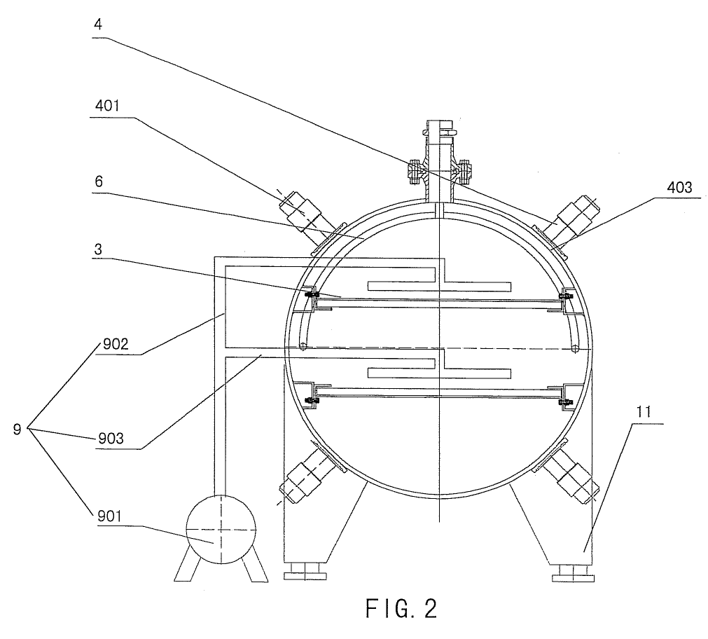

FIG. 1 is a schematic view showing a structure of a vacuum microwave drying apparatus according to the first embodiment of the present invention, and FIG. 2 is a sectional view cut along A-A line of FIG. 1.

As shown in FIG. 1 and FIG. 2, the vacuum microwave drying apparatus provided by the present invention mainly consists of a tank 1, tank closures 2, a vacuum system, a continuous feeding mechanism 9, a continuous discharging mechanism 10, at least two layers of material transferring mechanism 3 as well as a plurality of microwave heating means 4.

The tank 1 may has a cylinder shape as a whole, but the whole shape of the tank 1 is not limited to this, it may be any shape which can realize the objectives of the present invention. The tank 1 and tank closures 2 located at two ends of the tank 1 jointly define a containing space for containing the material transferring mechanisms 3. The tank 1 and the tank closures 2 may be made of a metal material to prevent the microwave for drying material from leaking from the tank body. The tank 1 and tank closures 2 are integrated together via a locking means 8. The tank 1 is held on the ground through supports 11.

The vacuum system is connected with the containing space through a vacuum pipe 5 to draw out water vapor and other gases generated during the drying process of the material, thereby keeping the vacuum of the containing space so as to help microwave transfer in the containing space.

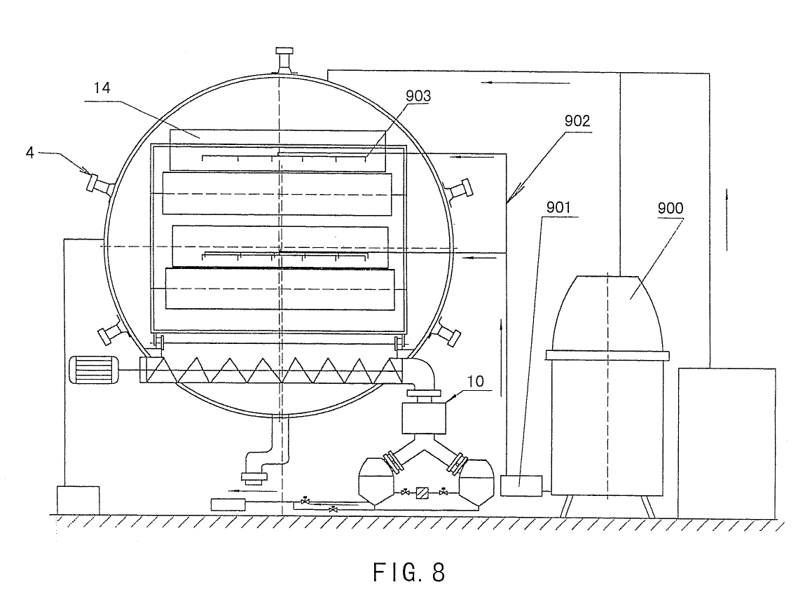

The continuous feeding mechanism 9 comprises a stirring kettle 900 (referring to FIG. 8), a feeding pump 901 and a feeding pipe 902. One end of the feeding pipe 902 is communicated with the feeding pump 901 and the other end extends into the containing space, after the material to be dried is stirred in the stirring kettle 900, it is transferred to the material transferring mechanism 3 continuously through the feeding pipe 902 under the driving of the feeding pump 901. The feeding pipe 902 comprises two feeding branch pipes 903, which extend to the material transferring mechanism 3 from the feeding pipe 902 and are provided with discharge port. The material arrives at the material transferring mechanism 3 from the feeding branch pipe 903 via discharge port to proceed to transportation. The quantity of the feeding branch pipes 903 is not limited to two, but is the same as the quantity of the material transferring mechanisms 3, so that one feeding branch pipe 903 for feeding material to the material transferring mechanism 3 is disposed above each material transferring mechanism 3.

The continuous discharging mechanism 10 may comprise: a material catching pot 1001, for catching the dried material transferred from the material transferring mechanisms 3; a spiral propeller 1002, for driving the material from the material transferring mechanisms 3 to the material catching pot 1001; and a discharge port 1003, which is communicated with the material catching pot 1001, the material is sent out of the containing space through the discharge port 1003 under the driving of the spiral propeller 1002.

Two layers of the material transferring mechanism 3 are arranged to be parallel to each other in the containing space along a longitudinal direction the of tank 1. In one of the preferred embodiments, each material transferring mechanism 3 comprises: a leading roll 31, which rotates under the driving of the drive unit such as motor; a driven roll 32, which is arranged opposite to the leading roll 31 so that the leading roll 31 and the driven roll 32 are located at the both sides of said containing space respectively; and an endless belt conveyor 33, which is looped on the leading roll 31 and the driven roll 32 and is provided with a carrying surface for loading material. In this embodiment, because each layer of material transferring mechanism 3 is arranged to be parallel to each other in the containing space, so the space occupied by the equipment can be reduced greatly. Though the material transferring mechanism 3 shown in FIG. 1 and FIG. 2 is of two layers, however, the layers of the material transferring mechanism 3 can be determined according to the demand of real production, such as 2-8 layers.

The material transferring mechanism 3 may be a flat belt transfer mechanism or a track transfer mechanism.

Each microwave heating means 4 comprises a microwave generator 401, a microwave conveyor 402 and a microwave feed-in opening 403. The microwave generator 401 is electrically connected to a microwave power supply so as to transfer the electric energy into the microwave energy. The microwave generator 401 may be, for example, a magnetron. The microwave conveyor 402 is used for transferring the microwave generated by the microwave generator 401 into the microwave feed-in opening 403. The microwave conveyor 402 may be, for example, a waveguide. Passing through the openings of the tank 1, the microwave feed-in openings 403 extend into the tank 1 and are arranged along an inner circumference direction of the tank 1, so as to transfer the microwave to the containing space in the tank 1.

In this embodiment, the microwave feed-in opening 403 may be arranged on the inner wall of the tank 1 and distributed uniformly in a radial direction of the tank 1. Though FIG. 1 shows that the microwave feed-in openings 403 are distributed uniformly on the inner circumference of the tank 1 along the longitudinal direction of the tank 1, however, the present invention is not limited to this, they can be arranged according to the demand of the uniformity and aging of the material drying. For instance, the distribution density of the microwave feed-in openings 403 may be increased near the region of the continuous discharging mechanism 10, while the distribution density of the microwave openings 403 may be decreased near the region of the continuous feeding mechanism 9, so that the material is dried more uniformly.

In order to facilitate an operator to observe the inner situation of the tank 1 when the material is dried, a monitoring system 7 may be arranged on the vacuum microwave drying apparatus of the present invention for monitoring the inner situation of the tank 1.

The vacuum microwave drying apparatus of the present invention may further comprise a clearing means 6 for clearing the inside of the tank 1 after the drying process is over.

When the material drying operation is performing, the material, driven by the feeding pump 901, passes through the feeding pipe 902 and the feeding branch pipe 903 in sequence and is transmitted to the carrying surface of the endless belt conveyor 33. Under the driving of the drive unit, the rotation of the leading roll 31 brings the rotation of the driven roll 32, consequently, the material is transferred to the continuous discharging mechanism 10 from the continuous feeding mechanism 9 by the endless belt conveyor 33. The microwave generated by each microwave generator 401 enters into the containing space via the respective microwave feed-in opening 403. Under the action of microwave energy, the water included in the material turns into a gas state from a liquid state rapidly and is discharged out of the tank 1 by the vacuum system, thereby the drying of material can be realized. The dried material is unloaded in the material catching pot 1001 of the continuous discharging mechanism 10, forwards to the discharge port 1003 under the driving of the spiral propeller 1002 and finally is sent out of the tank 1.

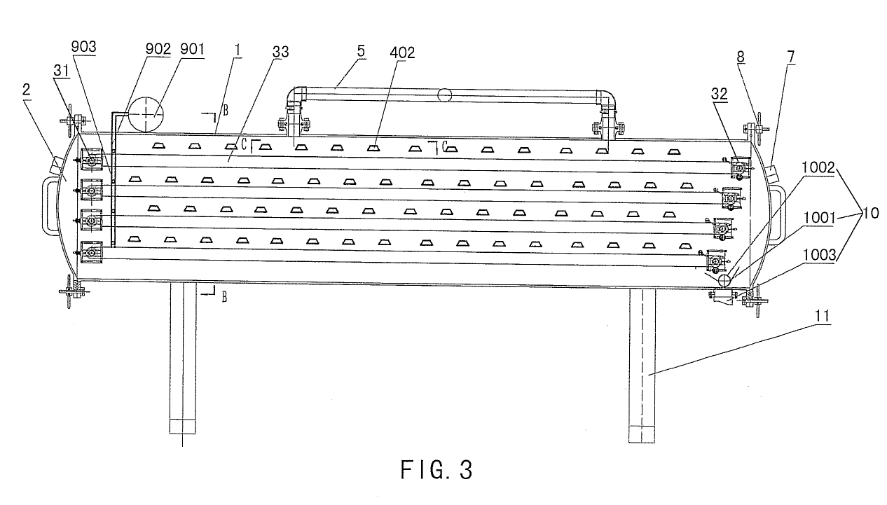

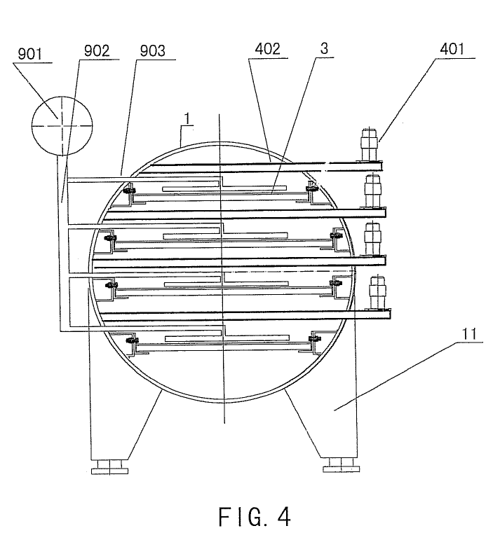

FIG. 3 is a schematic view showing a structure of a vacuum microwave drying apparatus according to the second embodiment of the present invention. FIG. 4 is a sectional view cut along line B-B of FIG. 3.

As shown in FIG. 3 and FIG. 4, the mainly structure difference between the second embodiment and first embodiment of the vacuum microwave drying apparatus of the present invention lies in that, the vacuum microwave drying apparatus of the present invention is provided with 4 layers of material transferring mechanism 3, and the microwave feed-in openings 403 of the microwave heating means 4 are arranged above each layer of the material transferring mechanism 3.

The microwave heating means 4 are disposed into a plurality of lines that are parallel to the material transferring mechanisms 3, and each line of microwave heating means 4 is corresponded to the position of each material transferring mechanism 3 one to one.

The microwave generators 401 of the microwave heating means 4 are arranged outside the tank 1. Although the microwave generators 401 are all placed on the right side of the tank 1 (i.e. right hand side in FIG. 4), the microwave generators 401 of this embodiment can also be placed on the left side of the tank 1 (i.e. left hand side in FIG. 4), alternatively, some of microwave generators 401 are placed on the left side of the tank 1 and some of them are placed on the right side of the tank 1.

In this embodiment, the length of each microwave conveyor 402 can be adjusted, so that the length of the parts of the microwave conveyors 402, that are above loop conveyor belt 33, is equal, or the length increase gradually along the transverse direction of tank 1 (in other words, along the transverse direction of the endless belt conveyor 33).

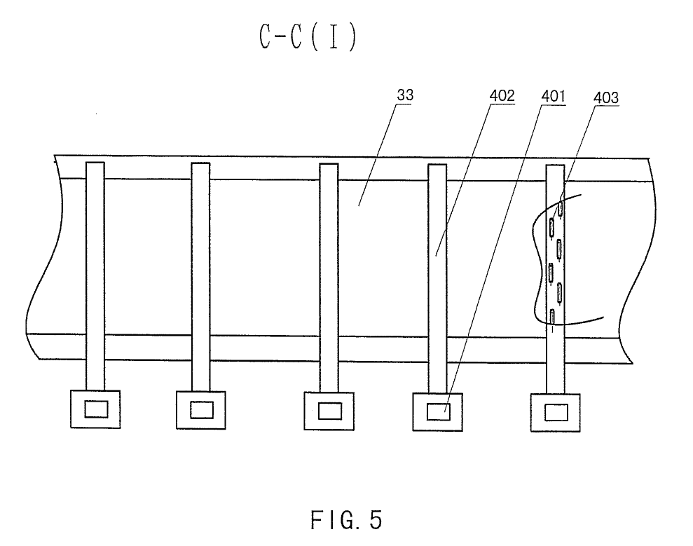

In case that the length of the parts of the microwave conveyors 402 that are above the loop conveyor belt 33 is equal, as shown in FIG. 5, the microwave openings 403 of the microwave conveyors 402 are arranged on one side of the microwave conveyor 402 that face towards the endless belt conveyor 33, so as to facilitate the microwave to be transferred to the material being carried on the endless belt conveyor 33.

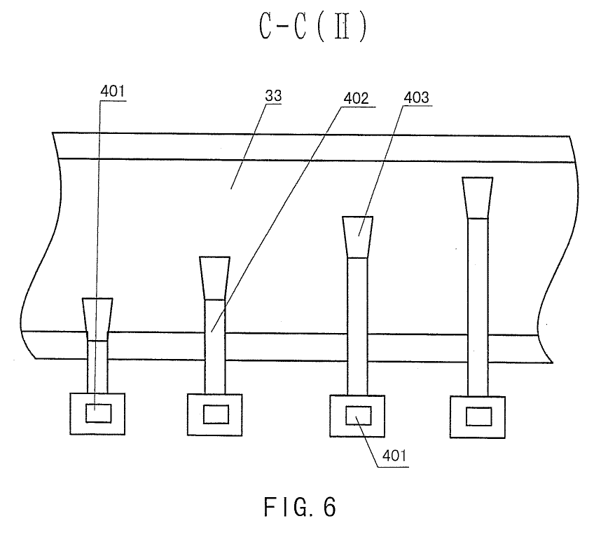

In case of the stepping up of the length of the microwave conveyors 402 along the transverse direction of the tank 1, as shown in FIG. 6, the microwave feed-in opening 403 is arranged at the free end of the microwave conveyor 402 so that the microwave energy outputted from the microwave feed-in opening 403 can uniformly irradiate the material being carried by the endless belt conveyor 33.

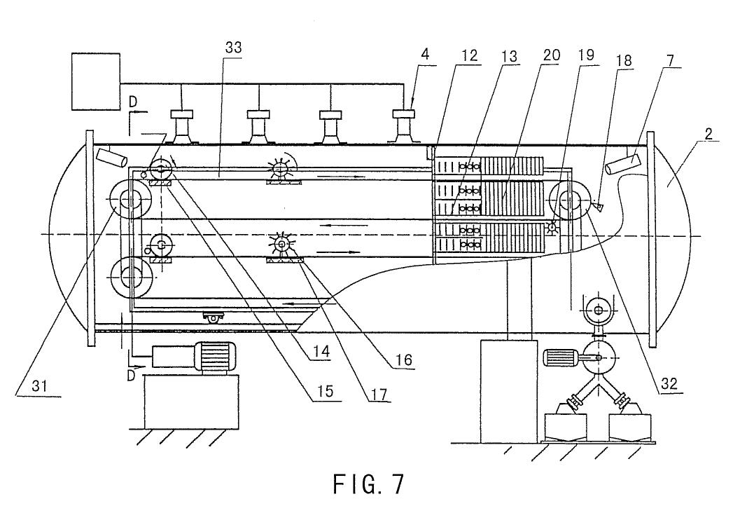

FIG. 7 is a schematic view showing a structure of a vacuum microwave drying apparatus according to the third embodiment of the present invention, in which a containing space in a tank is divided into a drying chamber and a cooling chamber by a separator. FIG. 8 is a sectional view cut along line D-D of FIG. 7.

As shown in FIG. 7 and FIG. 8, beside the structure provided by the first embodiment and second embodiment, the third embodiment further comprises a separator 12, a microwave suppressor 13 and a cooling unit.

The separator 12 divides the containing space in the tank 1 into a drying chamber disposed on the left hand in FIG. 7 (in other words, on the side of the feeding pipe 902) and a cooling chamber disposed on the right hand side in FIG. 7 (in other words, on the side of the material catching pot 1001). The separator 12 is made of a material which can obstruct the microwave from transmission, such as metal, to stop the microwave in the drying chamber and prevent the leakage of the microwave to the cooling chamber. The separator 12 is provided with a separator opening whose position and quantity is corresponding to those of the endless belt conveyor so that the endless belt conveyor 33 can pass through the separator opening.

The microwave suppressor 13, being provided with a suppressor opening for being passed through by the endless belt conveyor 33, is located in the cooling chamber and abuts against the separator 12. The microwave suppressor 13 is used for suppressing the microwave in drying chamber from going into the cooling chamber. The microwave suppressor 13 may be an absorption type microwave suppressor, a reflection type microwave suppressor or a filtration type microwave suppressor.

A cooling system is provided in the cooling chamber to keep the temperature in the cooling chamber lower. All kinds of common cooling process in the art can be used in the cooling system, for example, a cooling water pipe surrounding the endless belt conveyor 33 is used to cool the cooling chamber.

The microwave heating means 4 can be arranged according to the mode described in the first embodiment or the second embodiment, so as to dry the material in the drying chamber by utilizing the microwave.

As shown in FIG. 7, in order to dry the material more uniformly, a mill roll 14 may be arranged above the endless belt conveyors 33 and a mill slab 15 may be arranged below the endless belt conveyor 33. Both the mill roll 14 and the mill slab 15 co-operate each other to mill the material being carried on the carrying surface of the endless belt conveyor 33.

As shown in FIG. 7, in order to avoid agglomeration of the material, a cutter 16 may be arranged above each endless belt conveyors 33 and a cut-off slab 17 may be arranged below each endless belt conveyor 33. Both the cutter 16 and the cut-off slab 17 co-operate each other to cut the material.

In order to clear the material remaining on the carrying surface of the endless belt conveyor 33 after unloading, an elastic perching knife 18 and a hairbrush 19 can also be provided. The elastic perching knife 18 may be located near the outer circumference of the driven roll 32 with the knife nose of the elastic perching knife 18 touching the carrying surface of the endless belt conveyor 33, so as to clear the material remaining on the endless belt conveyor 33 after unloading. The hairbrush 19 may comprise many hairs and may be arranged on the downstream of the elastic perching knife 18 along the transmission direction of the endless belt conveyor 33. The hairs touch the carrying surface of the endless belt conveyor 33 to further clear the material remaining on the endless belt conveyor 33 after unloading.

The mill roll 14 and the mill slab 15, the cutter 16 and the cut-off slab 17, as well as the elastic perching knife 18 and hairbrush 19, all of them may also be applied to the first embodiment and second embodiment.

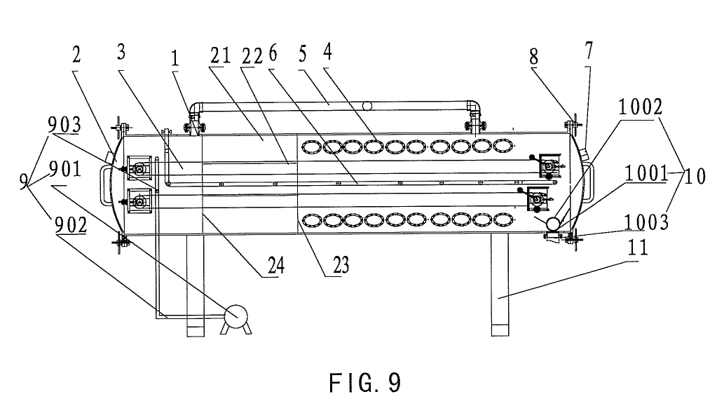

FIG. 9 is a schematic view showing a structure of a vacuum microwave drying apparatus according to the fourth embodiment of the present invention.

As shown in FIG. 9, the vacuum microwave drying apparatus of the present invention further comprises a frozen chamber 21, which defines a closed frozen space and is arranged in the containing space. The material transferred to the material transferring mechanism 3 by the feeding pipe 902 and the input branch pipe 903 is carried by the material transferring mechanism 3 and passes through the frozen chamber 21.

The frozen chamber 21 comprises: a first separation wall 23, made from a heat insulating material; a second separation wall 24, made from a heat insulating material and defining a closed operating space together with the first separation wall 23; and a refrigeration system 22, for refrigerating the operating space of the frozen chamber 21, so that the material in the operating space is frozen rapidly.

As shown in FIG. 9, the refrigeration system 22 only freeze the material being transferred by the material transferring mechanism 3, instead of freezing the material being transferred by the feeding pipe 902 and the input branch pipe 903, thereby it is avoidable that the material is frozen in the feeding pipe 902 and the input branch pipe 903 and the feeding pipe are blocked.

According to the fourth embodiment of the present invention, since the frozen chamber 21 is added in the feeding part of the vacuum microwave drying apparatus, after entering into the material transferring mechanism 3 through the feeding pipe 902 and the input branch pipe 903 and before receiving microwave energy drying, the material first pass through the frozen chamber 21, the refrigeration system 22 in the frozen chamber 21 will make the material frozen rapidly, and then the material enters into the drying chamber to receive microwave energy and vaporizes directly from a freezing point state without passing a liquid state. This method improves the maintenance of the available component in the material and preserves the nutrition and health ingredient of raw material as well as color, fragrance and shape. Meanwhile, the refrigeration system 22 does not refrigerate the feeding pipe 902 and the input branch pipe 903, so it is assured that the material would not be frozen in the feeding pipe 902 and the input branch pipe 903 to block the feeding pipe.

Compared with other drying method, the material drying process completed in a frozen state has the following features: 1. the shrinkage ratio of the final product is much smaller than the fresh material, so the organization structure and the appearance shape are maintained well; 2. due to a higher temperature gradient between the drying chamber and the cooling chamber, the moisture content in the material is decreased effectively, dehydration is proceeded completely, so the storage life is longer. 3. the vacuum freeze drying is performed at low temperatures and low pressures, furthermore, moisture content is vaporized without passing a liquid state, so the product of vacuum freeze drying can ensure that all kinds of nutrition ingredients in foodstuff, such as protein, vitamin, etc., especially those highly volatile and heat sensitive ingredient, would be not lost. Thus, the original nutrition ingredients are kept to the greatest extent, and the oxidation, the translation of the nutritional ingredient and the change of the liquid state during the drying process are prevented effectively. 4. the final product becomes sponginess, without drying shrinkage, the rehydration performance is excellent, it is convenient while eating, the containing water is little and it can be preserved and transported for a long time at ordinary temperature after packaging. Therefore, this product is endued with many special performances.

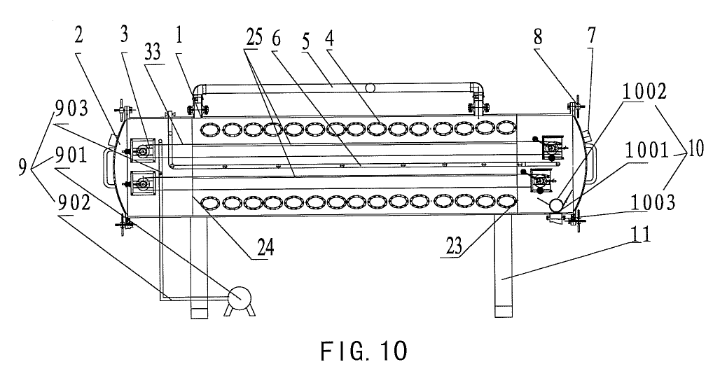

FIG. 10 is a schematic view showing a structure of a vacuum microwave drying apparatus according to the fifth embodiment of the present invention. As shown in FIG. 10, a refrigeration board 25 is provided in the containing space and below the endless belt conveyor 33 of the material transferring mechanism 3.

The refrigeration board 25 may be an intermittent type one, i.e., the material is, during the transportation, dried for a period, then frozen for a period, and then is dried again, repeating in this manner. It can reduce the moisture content in the dried material by means of improving the temperature gradient between the high temperature region and low temperature region.

The refrigeration board 25 can also be an integral type one, so that the material is dried while being frozen during the transportation. Accordingly, the material is dried directly during the freeze.

The above is the preferred embodiments of the present invention which is only for the explanation and interpretation, not for limiting the scope of patent protection of the present invention. The other equivalent changes and improvements made by those skilled in the art under the technique indication provided by the present invention should be regarded as falling into the scope of the present invention.

1. A vacuum microwave drying apparatus, comprising:
a tank;
a tank closure, defining a containing space together with the tank;
a vacuum system, communicated with the containing space via a vacuum tube;
a continuous feeding mechanism, comprising a feeding pipe communicated with the containing space, for transferring the material to the containing space continuously via the feeding pipe;
a continuous discharging mechanism, for discharging the dried material out of the containing space;
at least two layers of material transferring mechanism, provided in the containing space along a longitudinal direction of the tank and being parallel to each other in an up and down direction, for transferring the material to the continuous discharging mechanism from the continuous feeding mechanism; and
a plurality of microwave heating means, provided with microwave feed-in openings arranged in the containing space to transfer microwave to the containing space, the microwave is used for drying the material being carried on the material transferring mechanism.

2. The vacuum microwave drying apparatus according to claim 1, wherein the plurality of microwave heating means are arranged to be multi-line parallel to the material transferring mechanism, each line of the microwave heating means is corresponding with each layer of the material transferring mechanism respectively, so that the microwave feed-in openings of each line of microwave heating means approach to the material being carried on the corresponding layer of the material transferring mechanism.

3. The vacuum microwave drying apparatus according to claim 2, wherein the microwave heating means comprises:
a microwave generator, located outside the tank and being electrically connected with a microwave power supply to generate microwave;
a microwave conveyor, for conveying the microwave generated by the microwave generator to the microwave feed-in opening;
wherein the length of each microwave conveyor is equal, the microwave feed-in opening is arranged on the microwave conveyor and faces towards the material.

4. The vacuum microwave drying apparatus according to claim 2, wherein the microwave heating means comprises:
a microwave generator, located outside the tank and being electrically connected with a microwave power supply to generate microwave;
a microwave conveyor, for conveying microwave generated by the microwave generator to the microwave feed-in opening;
wherein the microwave feed-in opening is placed at a free end of the microwave conveyor, and the length of each microwave conveyor increases or decreases gradually along the transverse direction of the tank, so that the material being transferred by the material transferring mechanism can be fully irradiated by microwave.

5. The vacuum microwave drying apparatus according to claim 1, wherein the material transferring mechanism comprises one to eight layers.

6. The vacuum microwave drying apparatus according to claim 1, wherein the microwave feed-in opening is arranged at the inner circumference of the tank.

7. The vacuum microwave drying apparatus according to claim 6, wherein the microwave feed-in openings are arranged along the radial direction of said tank and are aligned to multi-line along an axial direction of the tank.

8. The vacuum microwave drying apparatus according to claim 6, wherein the material transferring mechanism comprises two layers.

9. The vacuum microwave drying apparatus according to claim 1, wherein the vacuum microwave drying apparatus further comprises a video monitoring system for monitoring the containing space.

10. The vacuum microwave drying apparatus according to claim 1, wherein the feeding pipe comprises a feeding branch pipe, whose quantity and position is correspondent to those of the material transferring mechanism, the continuous feeding mechanism still comprises:
a stirring kettle, for stirring the material; and
a transfer pump, being arranged in the pipe together with the stirring kettle, for transferring the material into the transferring mechanism in the containing space.

11. The vacuum microwave drying apparatus according to claim 1, wherein the continuous discharging mechanism comprise:
a material catching pot, for catching the dried material unloaded from the material transferring mechanism;
a spiral propeller, for pushing the material in the material catching pot; and
a discharge port, being communicated with the material catching pot, the material is discharged out of the containing space through the discharge port.

12. The vacuum microwave drying apparatus according to claim 1, wherein the material transferring mechanism comprises:
a leading roll, arranged at one end in the containing space and driven by a drive unit outside the tank;
a driven roll, arranged at the other end in the containing space; and
an endless belt conveyor, provided with a carrying surface for loading the material, and looped on the leading roll and the driven roll to transfer the material.

13. The vacuum microwave drying apparatus according to claim 1, wherein the vacuum microwave drying apparatus further comprises:
an elastic perching knife, arranged to touch the carrying surface of the material transferring mechanism so as to clear the material remaining on the endless belt conveyor after unloading; and
a hairbrush comprising many hairs, located at the downstream of the elastic perching knife and arranged to touch the carrying surface of the material transferring mechanism so as to clear the material remaining the endless belt conveyor after unloading.

14. The vacuum microwave drying apparatus according to claim 1, wherein the material transferring mechanism is a flat belt transfer mechanism or a track transfer mechanism.

15. The vacuum microwave drying apparatus according to claim 1, wherein the vacuum microwave drying apparatus further comprises:
a mill roll, located on the carrying surface of each material transferring mechanism, for milling the material on the carrying surface; and
a mill slab, located below the carrying surface of each material transferring mechanism, and cooperating with the mill roll to mill the material.

16. The vacuum microwave drying apparatus according to claim 1, wherein the vacuum microwave drying apparatus further comprises:
a cutter for cutting the material, located on the carrying surface of each material transferring mechanism; and
a cutting slab, located below the carrying surface of each material transferring mechanism, and cooperating with the cutter to cut the material.

17. The vacuum microwave drying apparatus according to claim 1, wherein the vacuum microwave drying apparatus further comprises:
a separator, made from a microwave separation material and dividing the containing space into a drying chamber and a cooling chamber, the drying chamber being connected with the continuous feeding mechanism, the cooling chamber being connected with the discharging mechanism, and the separator being provided with a separator opening whose position and quantity is corresponding to those of the endless belt conveyor so that the endless belt conveyor may pass through the separator opening; and
a cooling unit for cooling the material, located in the cooling chamber;
wherein a plurality of the microwave heating means are arranged in the drying chamber to dry the material in the drying chamber.

18. The vacuum microwave drying apparatus according to claim 17, wherein a microwave suppressor with a suppressor opening, through which the endless belt conveyor is passed, is further provided in the cooling chamber, the microwave suppressor is utilized to reduce the microwave leaked from the suppressor opening.

19. The vacuum microwave drying apparatus according to claim 18, wherein the microwave suppressor is an absorption type microwave suppressor, a reflection type microwave suppressor or a filtration type microwave suppressor.

20. The vacuum microwave drying apparatus according to claim 1, wherein the vacuum microwave drying apparatus further comprises a frozen chamber arranged in the containing space and defining a closed frozen space, and the material transferred to the material transferring mechanism via the feeding pipe is carried by the material transferring mechanism and passes through the frozen chamber.

21. The vacuum microwave drying apparatus according to claim 1, wherein an intermittent refrigeration board is arranged in the containing space and below the belt conveyor of the material transferring mechanism, so that the material is dried and refrigerated repeatedly during transportation of the material.

22. The vacuum microwave drying apparatus according to claim 1, wherein an integral refrigeration board is arranged in the containing space and below the belt conveyor of the material transferring mechanism, so that the material is dried while being refrigerated during transportation of the material.
